(19) United States
(12) Patent Application Publication
(10) Pub. No.: US 2009/0180732 A1
(43) Pub. Date: Jul. 16, 2009

(54) Junction Structure Between Optical Element and Substrate, Optical Transmission/Receiving Module, and Method of Manufacturing the Optical Module

(76) Inventors: Toshiaki TAKAI, Yokohama (JP); Akiko Mizushima, Yokohama (JP); Naoki Matsushima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/257,415

(22) Filed: Oct. 24, 2008

(30) Foreign Application Priority Data
Jan. 10, 2008 (JP) 2008-003046

(51) Int. Cl. G02B 6/12; B29D 11/00; G02B 6/26

(52) U.S. Cl. 385/14; 264/1.7; 385/31

(57) ABSTRACT

The present invention provides a junction structure between an optical element and a substrate. The junction structure is formed by supplying an under-fill resin not containing a filler to a portion functioning as a light path for light emitted from or incoming into the optical element on the substrate, then jointing a conductive bump of the optical element to electric wiring on the substrate, and then thermally hardening the under-fill resin not containing a filler to bond the resin not containing a filler to the optical element and to the substrate so that the under-fill resin containing a filler will not enter a space between the optical element and the substrate when the under-fill resin containing a filler is filled in portions other than the light path between the optical element and the substrate.

### BACKGROUND OF THE INVENTION

1. Field of the Invention

The present invention relates to a junction structure between an optical element and a substrate having an optical waveguide, an optical transmission/receiving module which is an optical wiring device using the junction structure, and a method of manufacturing an optical module. More specifically, the invention relates to a junction structure between an optical element packaged by means of the flip-chip bonding and a substrate and a method of manufacturing an optical module.

2. Description of the Related Art

Recently, an optical wiring device is used as a high-speed transmission line more and more in place of electric wiring owing to several reasons. The reasons are, for instance, that optical wiring devices are applicable in a high bit rate transmission as compared with the electric wiring, that optical wiring devices are excellent in resistance against noises caused by electromagnetic waves, and that a capacity required for optical wiring is smaller than that that required for electric wiring and also its weight is lighter. One of the most important factors in an optical wiring device is an optical coupling structure between an optical element such as a semiconductor laser or a photodiode and an optical transmission path such as an optical fiber or an optical waveguide. Mounting precision at the level of several tens μm is required for positioning the optical element and the optical transmission path even in a case of multimode transmission to achieve the high optical coupling efficiency. Furthermore, it is required that such troubles as positional displacement or separation should not occur even after completion of the testing for reliability in operations in a temperature cycle or at high temperatures and high humidity. On the other hand, the basic requirement for optical wiring is its lower price when it is compared with the cost for electric wiring. To satisfy this basic requirement, the material cost and the number of steps in assembly must be minimized.

A conceivable method of mounting an optical element that satisfies the requirements as described above is disclosed, for instance, in JP-A-2005-164801. In this method, surface light emitting/receiving elements such as a surface-emitting laser (VCSEL: Vertical Cavity Surface-Emitting Laser) or a surface light-receiving photodiode are mounted on a substrate by means of flip chip bonding and are optically coupled to a light transmission path under the substrate. With the approach as described above, the junction structure for optical elements can be realized with the substantially same process as the conventional one used for mounting electric components on an electronic circuit by means of flip chip bonding.

Furthermore, as described in JP-A-2005-333018, a projection made of a transparent resin is previously provided at a light-emitting/receiving section of an optical element. The optical wiring device disclosed in the publication has the configuration as follows. When the optical element is mounted and then the projection made of a transparent resin is pressed, a refractive index distribution is generated in the transparent resin portion to provide the function as a lens. Therefore the light emitted from or incoming into the optical element is condensed, so that the coupling efficiency in condensation is improved.

[Patent Document 1] JP-A-2005-164801

[Patent Document 2] JP-A-2005-333018

### SUMMARY OF THE INVENTION

When an optical element is mounted by means of flip chip bonding like in the conventional technique, generally an under-fill resin is filled in a space between the optical element and a substrate to ensure the junction strength, and to moderate stresses generated between the optical element and the substrate.

However, in JP-A-2005-164801, a transparent resin not containing a filler is used as the under-fill resin. Generally, it is preferable to use a resin containing a filler for mitigation of thermal stresses, because adjustment of a thermal expansion coefficient is relatively easy in the resin containing a filler. This is because that the thermal expansion coefficient of the under-fill resin is adjusted with that of the optical element as well as of the substrate to improve the reliability. However, in the optical coupling structure described in JP-A-2005-164801, when the resin containing the filler is used as the under-fill resin, because the under-fill resin is provided on the light path, the light loss disadvantageously increases because of light scattering by the filler or for some other reasons.

Furthermore, in the case described in JP-A-2005-333018, the projection made of the transparent resin is present on the optical element. Therefore, even if the resin containing a filler is used as the under-fill resin, it is difficult for the under-fill resin to enter the light path. However, because the projection made of a transparent resin is only tightly contacted with the substrate, sometimes the under-fill resin containing a filler enters the space between the projection and the substrate, which may cause increase of light loss.

The present invention has been made to solve the problems as described above in the conventional technique. An object of the present invention is to provide a junction structure between an optical element and a substrate capable of improving the efficiency in optical coupling and also capable of improving reliability in physical properties of the junction structure between the optical element and the substrate. This object is accomplished by preventing an under-fill or the like containing a filler from enter a light path between the substrate and the optical element, in which the under-fill or the like would otherwise inhibit propagation of outgoing light from the optical element or incoming light into the optical light. Another object of the present invention is to provide a light-emitting/receiving module using such a junction structure and a method of manufacturing optical modules.

To realize the object described above, the present invention provides a junction structure between an optical element and a substrate as described below, and the junction structure is characterized in that an under-fill material used in the junction structure has (1) the function of improving the efficiency in optical coupling (the function of improving the efficiency in optical coupling by providing an under-fill resin not containing a filler on a light path between the optical element and the substrate) and (2) the function of improving the reliability (the function of improving the reliability by providing an under-fill resin containing a filler in areas other than the light path between the optical element and the substrate). Specifically, the under-fill resin not containing a filler is supplied to a portion corresponding to a light path for light emitted from the optical element and/or for light incoming into the optical element, then the optical element is joined to electric wiring (electrodes) on the substrate via a conductive bump formed to the optical element, and the under-fill resin not containing a filler is thermally hardened to allow the under-fill resin not containing a filler to adhere to the optical element and the substrate. Thus, when the under-fill resin containing a filler is filled in areas other than the light path between the optical element and the substrate, the under-fill resin containing a filler is prevented from entering the portion corresponding to the light path between the optical element and the substrate.

The present invention provides a junction structure between an optical element and a substrate, the optical element formed of a light-emitting element or a light-receiving element and formed with a bump, the substrate having an optical waveguide that is optically coupled to the optical element, the bump being connected to electric wiring (electrode) on the substrate, wherein a transparent resin not containing a filler is applied to a portion of a light path for outgoing light from the optical element to the substrate or a portion of a light path for incoming light from the substrate to the light-receiving element in such a manner that the transparent resin not containing a filler adheres to near a light-emitting point at which the optical element emits light and to the substrate; and a resin containing a filler is filled in a portion between the optical element and the substrate, the portion being to be filled with the resin containing a filler.

In the junction structure between an optical element and a substrate according to the present invention, preferably the transparent resin not containing a filler may be made of a transparent resin having a refractive index substantially equal to that of the substrate to which the transparent resin not containing a filler is made to adhere.

In the junction structure between an optical element and a substrate according to the present invention, preferably the transparent resin not containing a filler may be filled in an opening formed in a portion of the substrate that is made to adhere, the potion associated with the light path for outgoing and incoming light, for enabling passage of the outgoing and incoming light therethrough.

The present invention provides a light-emitting/receiving module having the junction structure between the optical element and the substrate described above.

The light-emitting/receiving module according to the present invention may mount on the substrate a driver for driving the optical element and an output signal amplifier for the light-receiving element.

Furthermore, preferably the substrate may have flexibility in the light-emitting/receiving module according to the present invention.

The present invention also provides a method of manufacturing an optical module, the method comprising: a first step of supplying a transparent resin not containing a filler to a portion of a substrate having an optical waveguide that is optically coupled to an optical element, the portion functioning as a light path for light emitted from the optical element and/or for light incoming into the optical element; a second step of mounting a bump provided for the optical element to electric wiring (electrode) on the substrate with the transparent resin not containing a filler supplied thereon in the first step and joining the bump to the electric wiring; a third step of allowing the transparent resin not containing a filler to adhere to the optical element and the substrate by thermally hardening the transparent resin not containing a filler in the state where the bump of the optical element is joined to the electric wiring (electrode) on the substrate in the second step; a fourth step of filling an under-fill resin containing a filler in a space between the light-receiving element and the substrate, to both of which the transparent resin not containing a filler has adhered in the third step; and a fifth step of thermally hardening the under-fill resin containing a filler filled in the fourth step.

According the present invention, in the third step, preferably the transparent resin not containing a filler may be thermally hardened such that the transparent resin not containing a filler adheres to only a portion near the light-emitting point or the light-receiving point of the optical element.

According the present invention, in the first step, preferably an opening may be formed in the portion through which light is to pass, before the transparent resin not containing a filler is supplied to the portion of the substrate functioning as the light path.

With the present invention, it is possible to realize to provide a satisfactory junction structure between an optical element and a substrate with an optical waveguide capable of improving the efficiency in optical coupling and also capable of improving reliability in physical properties of the junction structure by preventing an under-fill or the like containing a filler from entering a light path between the substrate and the optical element, in which the under-fill or the like would otherwise inhibit propagation of outgoing light from the optical element or incoming light into the optical light.

### BRIEF DESCRIPTION OF THE DRAWINGS

FIGS. 1A to 1E are schematic views illustrating a junction structure between an optical element and a substrate having a light transmission path and a method of manufacturing an optical module according to a first embodiment of the present invention;

FIG. 2 is a cross-sectional view illustrating a light-transmitting/receiving module which is an optical wiring device using the junction structure between the optical element and the substrate according to the first embodiment of the present invention;

FIGS. 3A and 3B are views illustrating how to fill an under-fill resin containing a filler in the light-transmitting/receiving module which is an optical wiring device using the junction structure between the optical element and the substrate according to the first embodiment of the present invention; and

FIGS. 4A to 4E is schematic views illustrating a junction structure between an optical element and a substrate having a light transmission path and a method of manufacturing an optical module according a second embodiment of the present invention.

### DESCRIPTION OF THE PREFERRED EMBODIMENTS

Junction structures between an optical element and a substrate, optical wiring devices each using the junction structure, and a method of manufacturing the optical wiring device according to embodiments of the present invention are described below with reference to the drawings. It is to be noted that the same reference numerals are assigned to the same components in the following figures, and detailed descriptions thereof will be omitted.

### First Embodiment

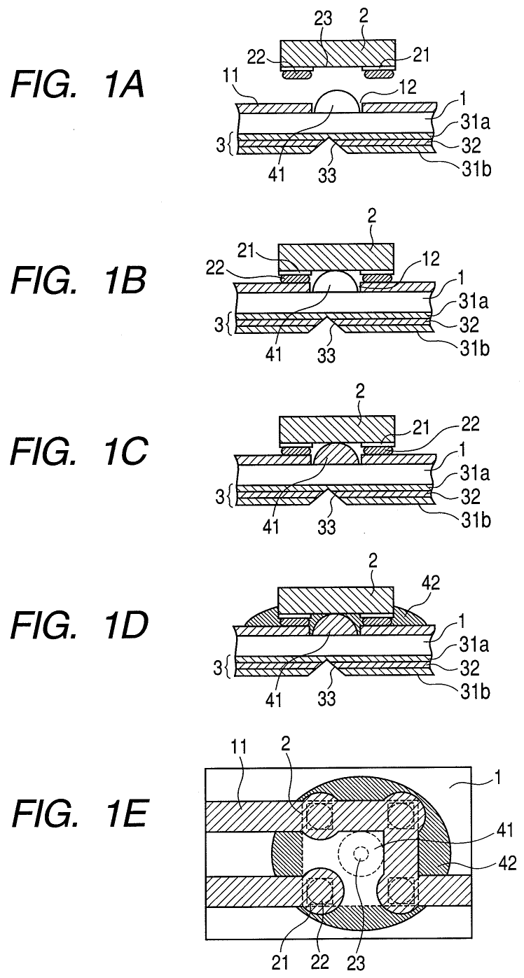

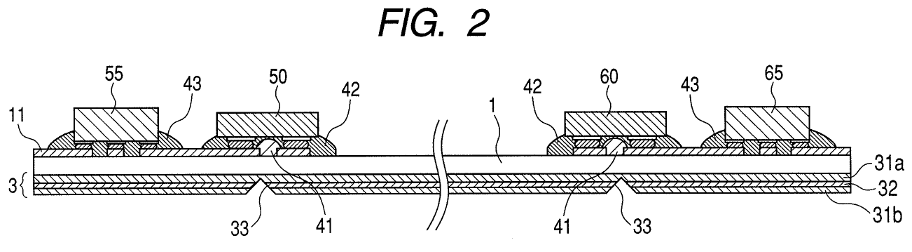

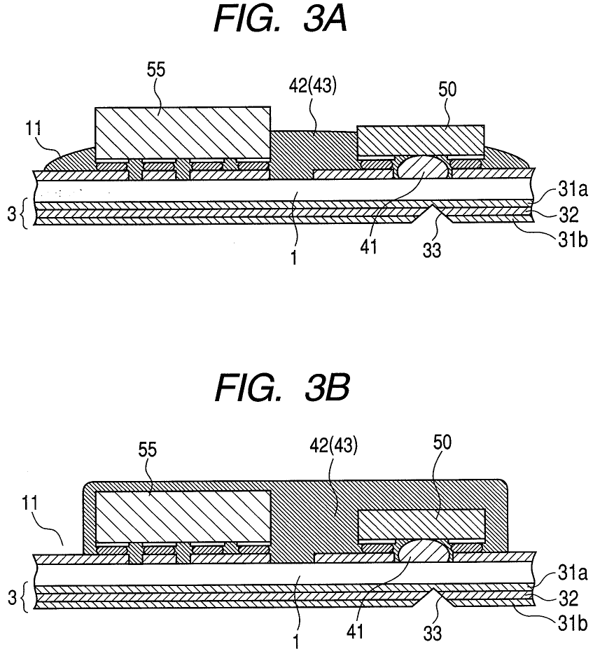

A junction structure between an optical element and a substrate having a light transmission line, a method of manufacturing an optical module, and an optical wiring device using the junction structure between an optical element and a substrate according to a first embodiment of the present invention are described below with reference to FIGS. 1A to 1E and FIG. 3. FIGS. 1A to 1E are views illustrating a junction structure between an optical element and a substrate using an Au bump and a method of manufacturing an optical module according to the first embodiment. FIG. 2 and FIGS. 3A and 3B are views each illustrating a cross section of a light-transmitting/receiving module which is an optical wiring device using the junction structure between an optical element and a substrate according to the first embodiment. FIG. 1A to FIG. 1D are views each illustrating a cross section of the junction structure between an optical element and a substrate according to the first embodiment. FIG. 1E is a view illustrating a transparent plan view illustrating the junction structure between an optical element and a substrate according to the first embodiment. Those skilled in the art will be able to easily understand that views illustrating cross-sections are developed cross-sectional views because an upper surface and a lower surface of the substrate are not identical in each of the views. This is also applicable to embodiments described below.

Referring to FIG. 1A, electric wiring (electrode) 11 is formed on a surface of a substrate 1. In the first embodiment of the present invention, the substrate 1 is a flexible substrate formed of a polyimide film. The electric wiring 11 is generally made of a rolled 12 μm-thick-Cu, and its surface is plated with 2 to 5 μm-thick-Ni and 0.3 μm-thick-Au. Other materials may be used for the wiring. However, it is desirable that the materials satisfy the requirements generally requested for electric wiring such as a small electric resistance, a low cost, and excellent workability. A material for plating a surface of the electric wiring 11 is selected according to a method of joining an optical element 2 thereto. In the first embodiment of the present invention, the surface is plated with 0.3 μm-thick-Au because Au—Au ultrasonic bonding is applied. It is needless to say that when an Al bump is used Al may be used as a material for plating the surface of the electric wiring. When junction is performed by soldering, an intermetallic compound is formed on an interface between the soldering material and Au. This intermetallic compound is hard and the stress buffering effect is poor, so that the reliability of the junction against physical impacts or the like is decreased. Furthermore, when Au remains and is exposed to high temperature, the intermetallic compound grows further, with the result that positional displacement of the optical element 2 may disadvantageously occur. To prevent the troubles as described above, it is preferable that the thickness of the Au layer be as thin as 0.05 μm.

Provided on a rear surface of the substrate 1 is an optical waveguide layer 3 comprising an optical waveguide core 32 made of a resin and optical waveguide claddings 31a, 31b. A 45° mirror (45 angle mirror) 33 is formed at the optical waveguide layer, and when the optical element 2 is a light-emitting element, the 45° mirror (45 angle mirror) reflects a light beam emitted (outgoing) from the light-emitting element (from the upper part of the figure) from left to right on a plane of the figure and guides the light beam into the optical waveguide core 32. When the optical element 2 is a light-receiving element, the 45° mirror 33 reflects the light beam propagating from right to left on the figure plane from down to top also on the figure plane and the light beam is received (incomes into) by the optical element 2. The following description of the first embodiment of the present invention assumes a case in which a VCSEL (Vertical Cavity Surface-Emitting Laser) is used as the optical element 2. It is to be noted that the same effect is achieved regardless of whether the optical element 2 is a light-emitting element or a light-receiving element.

In the first embodiment, before the optical element 2 is mounted on the substrate 1, a small amount of under-fill resin 41 not containing a filler is transcribed (supplied) onto the polyimide film constituting the substrate 1 by using, for instance, a transcribing mechanism. The small amount of under-fill resin 41 not containing a filler is transcribed (supplied) onto a portion of the polyimide film constituting the substrate 1, wherein this portion corresponds to a light path for light (outgoing light) emitted from the optical element (light-emitting element) 2 or light (incoming light) received by the optical element 2 (light-receiving element). A refractive index of the under-fill resin 41 not containing a filler is preferably adjusted to that of the polyimide film constituting the substrate 1. In the first embodiment, in order that such an adjustment is achieved, Kapton (with a refractive index of 1.78) is used as the polyimide film constituting the substrate 1, and EPO-TEK323LP (with a refractive index of 1.57) produced by Epoxy Technology Co., Ltd. is used as the under-fill resin 41 not containing a filler such that the difference in refractive index between the substrate 1 and the under-fill resin 41 not containing a filler is 0.25 or less. This enables to reduce light loss caused by Fresnel reflection on the interface between the under-fill resin 41 not containing a filler and the substrate 1 due to a difference in refractive index of the two components.

Furthermore, it is preferable that the under-fill resin 41 not containing a filler be filled only in an area near a light-emitting point (20 to 30 μmgφ) or a light-receiving point 23. This limitation is required to minimize effects resulting from thermal expansion of the under-fill resin 41 not containing a filler because the thermal expansion coefficient of the under-fill resin not containing a filler is generally large (thermal expansion coefficient of 130 ppm/K in this embodiment). A small amount of the under-fill resin 41 is supplied, for instance, by transcription in this embodiment, but the under-fill resin 41 may be supplied by dispensing.

On the other hand, an electrode 21 of the optical element 2 is formed with a conductive bump 22 made of Au. Although a bump formed by cutting a wire after first joining for wire bonding is used as the conductive bump 22 in the first embodiment, an Au-plated bump may be used for the conductive bump 22. In the first embodiment, an Au bump is used as the conductive bump 22 so as to join the optical element 2 to the substrate 1 by ultrasonic bonding, but the junction may be realized also by soldering. In this case, it is desirable to use, as the conductive bump 22, a solder ball with a melting point (from about 130 to about 140° C.) lower than an allowable temperature limit of the material used for forming the optical waveguide layer 3 (from about 150 to about 160° C.) such as Sn-1Ag-57Bi, or In-3.5Ag.

Then, as shown in FIG. 1B, the conductive bump 22 of the optical element 2 is joined to the electric wiring (electrode) 11 on the substrate 1, for instance, by ultrasonic bonding. At the same time, the vertex of the under-fill resin 41 not containing a filler, which has been supplied to a portion corresponding to a light path on the polyimide film constituting the substrate 1, is crushed, so that only the area near the light-emitting point and/or the light-receiving point 23 of the optical element 2 comes in close contact with the under-fill resin 41. When the joining operation by ultrasonic bonding is performed, the conductive bump 22 deforms and Au-Au diffusion occurs, so that the conductive bump 22 is joined to the electric wiring 11 on the substrate 1. During this step, the under-fill resin 41 not containing a filler, which is previously supplied to the portion corresponding to the light path on the substrate 1, is present on the portion corresponding to the light path in a space between the substrate 1 and the optical element 2.

Then, after the optical element 2 is joined to the substrate 1, the under-fill resin 41 not containing a filler is thermally hardened as shown in FIG. 1C such that the substrate 1 is bonded to the under-fill resin 41 not containing a filler and also the optical element 2 is bonded to the under-fill resin 41. Therefore, it is possible to prevent a material inhibiting propagation of light outgoing from the optical element 2 and/or light incoming into the optical element 2, i.e., an under-fill resin 42 containing a filler from entering the light path in the space between the substrate 1 and the optical element 2.

As described above, the present invention is characterized in that a small amount of the under-fill resin 41 not containing a filler is supplied to a portion corresponding to a light path on a polyimide film constituting the substrate 1 for light emitted from the optical element (light-emitting element) 2 and/or light incoming into the optical element (light-receiving element) 2, then the conductive bump 22 of the optical element 2 is joined to the electric wiring (electrode) 11 on the substrate 1, and the small amount of under-fill resin 41 not containing a filler is thermally hardened to be bonded to the optical element 2 as well as to the substrate 1. The junction structure between an optical element and a substrate according to the present invention is manufactured as described above. Therefore, when the under-fill resin 42 containing a filler is supplied to a portion other than the portion corresponding to the light path between the optical element 2 and the substrate 1, which will be described later, it is possible to prevent a material inhibiting propagation of light outgoing from the optical element 2 (outgoing light) and/or light incoming into the optical element 2 (incoming light), i.e., an under-fill resin 42 containing a filler from entering the light path in the space between the substrate 1 and the optical element 2.

As shown in FIG. 1D, the under-fill resin 42 containing a filler is filled in the space between the substrate 1 and the optical element 2. In this step, because the under-fill resin 41 not containing a filler has been thermally hardened, even when the under-fill resin 42 containing a filler is filled in the space between the substrate 1 and the optical element 2, the under-fill resin 42 containing a filler never enters the light path for light emitted from the optical element (light-emitting element) 2 and/or light incoming into the optical element (light-receiving element) 2. Thus, the light emitted from the optical element (light-emitting element) 2 (outgoing light) is introduced into an optical waveguide core 32 without scattering. Furthermore, the light from the optical waveguide core 32 is received by the optical element (light-receiving element) 2 without scattering. Because the under-fill resin 42 containing a filler is filled and then thermally hardened, stress caused by physical impact from the outside can be mitigated. Furthermore, it is possible to give various characteristics to the under-fill resin 42 by selecting a material to be added as a filler to the under-fill resin 42. For instance, when a material such as silica is added as a filler to the under-fill resin 42 to adjust the thermal expansion coefficient, it is possible to prevent boundary separation due to a difference between a thermal expansion coefficient of the substrate 1 and that of the optical element 2. The under-fill resin 42 containing a filler preferably has a thermal expansion coefficient ranging between a thermal expansion coefficient of the substrate 1 and that of the optical element 2. In the first embodiment of the present invention, the InP-based VCSEL (with a thermal expansion coefficient of 4.5 ppm/K) is used as the optical element 2, while Kapton (with a thermal expansion coefficient of 20 ppm/K) is used as a polyimide film constituting the substrate 1. To mitigate stress caused by the difference between the thermal expansion coefficients of the two materials, the under-fill resin 42 containing a filler preferably has a thermal expansion coefficient ranging from 4.5 to 20 ppm/K.

As described above, the junction structure between the substrate 1 with the optical waveguide layer 3 having the optical waveguide core 32 and optical waveguide claddings 31a, 31b formed thereon and the optical element 2 according to the present invention is shown by the transparent plan view in FIG. 1E. In FIG. 1E, the optical element 2 is shown by a broken line. The substrate 1 and the optical element 2 are joined to each other at four points. A light-emitting point or a light-receiving point 23 is formed at a central portion of the optical element 2. The 45° mirror 33 and the optical waveguide (optical waveguide layer) 3 are formed just below the light-emitting point or the light-receiving point 23 as shown in each of FIGS. 1A to 1D.

A material for the substrate 1 is not limited to polyimide, and any other type of resin may be used so long as the resin is transparent and allows propagation of light in the wavelength for communications. Although the ultrasonic bonding is employed as a method of jointing an optical element to a substrate in the first embodiment of the present invention, other methods such as soldering or bonding with a conductive adhesive or the like may be employed. When soldering is employed, it is preferable to use, as the conductive bump 22, a Pb-free solder ball having a melting point (from about 130 to about 140° C.) lower than an allowable temperature limit (from about 150 to about 160° C.) of a material used to form the optical waveguide layer 3 such as Sn-1Ag-57Bi, or In-3.5Ag. When a conductive adhesive is used, the temperature for thermally hardening is preferably lower than an allowable temperature limit (from about 150 to about 160° C.) for the material used for forming the optical waveguide layer 3.

Next, description will be made on an optical light-transmitting/receiving module which is an optical wiring device using the junction structure between an optical element and a substrate having a light transmission path according to the first embodiment of the present invention with reference to FIG. 2, FIGS. 3A and 3B. Referring to FIG. 2, a VCSEL (Vertical Cavity Surface-Emitting Laser) 50, a driver IC 55 for driving the VCSEL 50, a photodiode (PD) 60, and a preamplifier IC 65 for amplifying minute signals from the PD 60 at low noises are mounted to the electric wiring on an upper surface of the substrate 1 by means of flip chip bonding. The under-fill resin 41 not containing a filler is applied to a portion corresponding to a light path in the space between the VCSEL 50, the PD 60, and the substrate 1 in such a manner that the under-fill resin 41 is made to adhere to the optical element 50, PD 60 as well as the substrate 1. In contrast, the under-fill resin 42 containing a filler is filled in other portions. An under-fill resin 43 containing a filler is filled also in the driver IC 55 and the preamplifier IC 65.

FIGS. 3A and 3B are views each illustrating another method of filling the under-fill resin 43 containing a filler in the driver IC 55 and the preamplifier IC 65. For convenience, only the side of the VCSEL 50 and the driver IC 55 is shown in FIGS. 3A and 3B, but it is needless to say that the same filling method can be applied also to the side of the PD 60 and the preamplifier IC 65. As shown in FIG. 3A, the under-fill resin 43 containing a filler may be used together with the under-fill resin 42 containing a filler for filling portions other than light paths for the VCSEL 50 and the PD 60. Furthermore, as shown in FIG. 3B, the under-fill resin 42 containing a filler may be filled after the VCSEL 50, the driver IC 55, the PD 60, and the preamplifier IC 65 are sealed in batch by using the under-fill resin 42 containing a filler and then vacuum debubbling is performed.

Furthermore, provided on a bottom surface of the substrate 1 are the optical waveguide layer 3, and the 45° mirror 33 formed by dicing the optical waveguide layer 3 just below the light-emitting point of the VCSEL 50 and the light-receiving surface of the PD 60. Thus, the driver IC 55 having received an electric signal not shown generates an optical signal by modulating a laser beam from the VCSEL 50. The optical signal generated by the VCSEL 50 is guided to the optical waveguide core 32 by the 45° mirror 33 just below the VCSEL 50 and propagates through the optical waveguide core 32. Furthermore, the propagating optical signal is reflected via the 45° mirror below the PD 60 and is received by the PD 60. The PD 60 converts the optical signal to an electric signal, which is amplified by the preamplifier IC 65. Because the substrate 1 and the optical waveguide layer 3 each have flexibility, they can be used as wiring for transmitting and receiving signals in portions to be bent in flip-top devices such as mobile phones.

It is to be noted that the configuration shown in FIGS. 3A and 3B can be used also in other embodiments.

### Second Embodiment

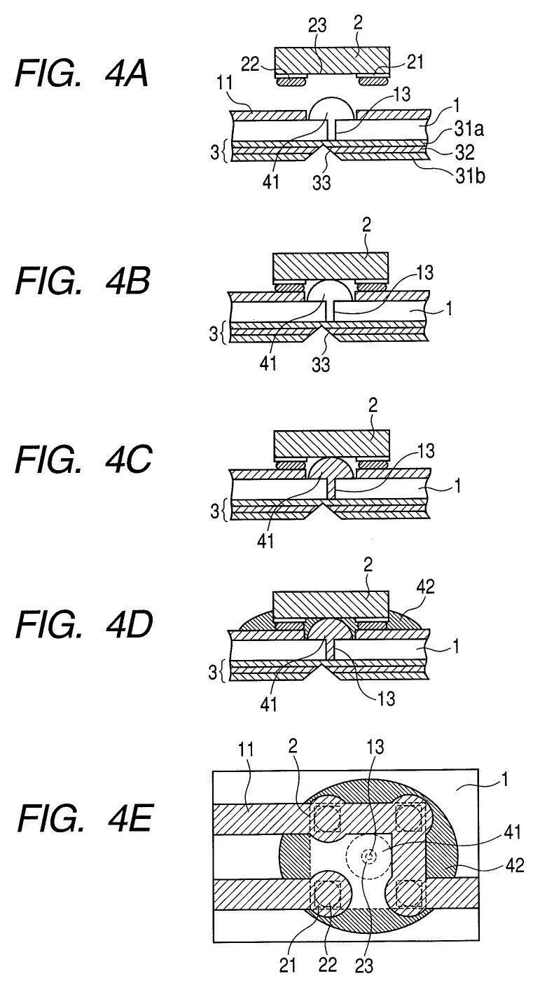

A junction structure between an optical element and a substrate having a light transmission path and a method of manufacturing the light module according to a second embodiment of the present invention will be described below with reference to FIGS. 4A to 4E. FIGS. 4A to 4D are views each illustrating a cross section of the junction structure for an optical element according to the second embodiment, and FIG. 4E is a transparent plan view illustrating the junction structure for an optical element according to the second embodiment. Also in descriptions of the second embodiment, it is assumed that Kapton is used as a polyimide film constituting the substrate 1 and a VCSEL is used as the optical element 2.

The first embodiment shown in FIGS. 1A to 1E is different from the second embodiment in that an opening 13 is provided in the polyimide film (for instance, Kapton) constituting the substrate 1, as shown in FIGS. 4A to 4E. The under-fill resin 41 not containing a filler is filled in the opening 13 and adheres thereto without generation of air bubbles when thermally hardened. Further, the opening 13 is provided at a portion associated with a position at which the light-emitting point and/or light-receiving point 23 of the optical element 2 is set.

More specifically, in the second embodiment of the present invention, the opening 13 is provided in the polyimide film constituting the substrate 1 in addition to the configuration according to the first embodiment as shown in FIG. 1A. The opening 13 is provided at a portion in the polyimide film constituting the substrate 1, with the portion being associated with a position at which the light-emitting point and/or light-receiving point 23 of the optical element 2 are located. In this configuration, the light emitted from the optical element 2 passes through the opening 13. The opening 13 is provided and formed on the polyimide film constituting the substrate 1 by laser machining, and its size should be preferably as small as possible. The second embodiment employs an opening having a diameter of about 50 μm. It is needless to say that the method of forming the opening 13 is not limited to laser machining, and that a technique such as etching or punching may be used for the purpose.

In the second embodiment, provided on a rear surface of the substrate 1 are the optical waveguide layer 3 comprising the optical waveguide core 32 made of a resin and optical waveguide claddings 31a, 31b. The 45° mirror 33 is formed at a position on the optical waveguide layer 3, with the position being associated with the opening 13. When the optical element 2 is a light-emitting element, the light having passed through the opening 13 is reflected on the 45° mirror 33 and is guided to the optical waveguide core 32. When the optical element is a light-receiving element, the optical waveguide guided by the optical waveguide core 32 is reflected on the 45° mirror 33 and is received via the opening 13 by the light-receiving element.

The configuration of the electric wiring 11 on the substrate 1 in the second embodiment is the same as that in the first embodiment.

In the second embodiment shown in FIG. 4A, like in the first embodiment shown in FIG. 1A, the under-fill resin 41 not containing a filler is transcribed (supplied) to a position at which the opening 13 is located in a substrate opening 12 before the optical element 2 is joined to the substrate 1. In this step, it is essential that the under-fill resin 41 not containing a filler is tightly filled inside the opening 13. Unless the under-fill resin 41 not containing a filler is sufficiently filled in the opening 13, when the under-fill resin 41 is thermally hardened in the state where air bubbles are present within the opening 13, the light emitted from the optical element 2 is scattered by the air bubbles, which may cause increase of light loss. To prevent such drawbacks, vacuum debubbling is performed, if required, so that the under-fill resin 41 is tightly filled in the opening 13.

It is desirable that a refractive index of the under-fill resin 41 not containing a filler be adjusted to that of the material for the optical waveguide cladding 31. This is required to minimize light loss due to Fresnel reflection on a boundary between the under-fill resin 41 and the optical waveguide cladding 31a like in the first embodiment. At the same time, it is desirable that a refractive index of the under-fill resin 41 be smaller than that of the polyimide film (Kapton) constituting the substrate 1. This is because that when a refractive index of the under-fill resin 41 not containing a filler (EPO-TEK 323LP (with a refractive index of 1.57) produced by Epoxy Technology Co., Ltd.) is smaller than that of the polyimide (such as Kapton (with a refractive index of 1.78)) constituting the substrate 1, it is possible to prevent light at the position of the opening 13 from leaking outside the under-fill resin 41. In other words, it is possible to improve the efficiency in optical coupling by providing the same effect as that obtained by the optical waveguide at the position of the opening 13.

FIG. 4B is a view illustrating the state where the optical element 2 is joined to the substrate 1 by means of ultrasonic bonding like in the first embodiment shown in FIG. 1B. When the joining operation by ultrasonic bonding is performed, the conductive bump 22 deforms and Au-Au diffusion occurs, so that the conductive bump 22 is joined to the electric wiring 11 on the substrate 1. When the junction is achieved, the under-fill resin 41 not containing a filler having been transcribed (supplied) to the substrate 1 is present in a portion corresponding to a light path in the space between the substrate 1 and the optical element 2.

FIG. 4C is a view showing, like in FIG. 1C, the state where the optical element 2 is joined to the substrate 1 by means of ultrasonic bonding and then the under-fill resin 41 not containing a filler is thermally hardened. When the under-fill resin 41 not containing a filler is hardened, the substrate 1 adheres to the under-fill resin 41 not containing a filler, the optical element 2 adheres to the under-fill resin 41 not containing a filler, and the optical waveguide layer 3 adheres to the under-fill resin 41 not containing a filler. Thus, like in the first embodiment, it is possible to prevent a material inhibiting propagation of light outgoing from the optical element 2 and/or light incoming into the optical element 2 (for instance, the under-fill resin 42 containing a filler) from entering the light path in the space between the substrate 1 and the optical element 2.

FIG. 4D is a view illustrating, like in FIG. 1D, the state in which the optical element 2 is joined to the substrate 1 by means of ultrasonic bonding, the under-fill resin 41 not containing a filler is thermally hardened, and then the under-fill resin 42 containing a filler is filled in the space between the substrate 1 and the optical element 2 and thermally hardened there. Also in the second embodiment, it is desirable that the under-fill resin 42 containing a filler have a thermal expansion coefficient ranging between a thermal expansion coefficient of the substrate 1 and that of the optical element 2.

FIG. 4E is a transparent plan view illustrating the state in which the substrate 1 and the optical element 2 have been joined to each other like in FIG. 1E. In FIG. 4E, the optical element 2 is shown by a broken line. The substrate 1 and the optical element 2 are joined to each other at four points. A light-emitting point and/or a light receiving point 23 is provided at a central portion of the optical element 2. The opening 13 is present just below the light-emitting point or/and light-receiving point 23, and the 45° mirror 33 and the optical waveguide 3 are formed there.

Also in the second embodiment, a material for the substrate 1 is not limited to polyimide, and any other type of resin may be used so long as the resin is transparent and allows propagation of light in the wavelength for communications. Furthermore, although the ultrasonic bonding is employed as a method of joining an optical element to a substrate, other methods such as soldering or bonding with a conductive adhesive or the like may be employed. When soldering is employed, it is preferable to use, as the conductive bump 22, a Pb-free solder ball having a melting point (from about 130 to about 140° C.) lower than an allowable temperature limit (from about 150 to about 160° C.) of a material used to form the optical waveguide layer 3 such as Sn-1Ag-57Bi, or In-3.5Ag. When a conductive adhesive is used, the temperature for thermally hardening is preferably lower than an allowable temperature limit (from about 150 to about 160° C.) for the material used for forming the optical waveguide layer 3.

With the first and second embodiments of the present invention described above, the following effects can be expected.

(1) An under-full resin not containing a filler and an under-fill resin containing a filler can be used at the same time, and both improvement in the efficiency in optical coupling and improvement in the reliability can be achieved simultaneously.

(2) An under-fill resin not containing a filler can be selectively used by taking into consideration only the adjustment of refractive index, and light loss due to Fresnel reflection can be reduced.

(3) An under-fill resin containing a filler can be selectively by taking into consideration only the adjustment of thermal expansion coefficient, and a boundary separation resulting from a difference in thermal expansion coefficients can be suppressed, which enables improvement of the reliability.

The present invention can be applied to the field relating to information and communication devices using optical wiring devices having a junction structure between an optical element and a substrate equipped with a light transmission path. Examples of such a filed include optical communication modules, optical recording modules, high-speed switching devices (such as routers, and servers), storage devices, communication devices for private use (mobile phones or the like), and vehicles.

What is claimed is:

1. A junction structure between a light-emitting element and a substrate, the light-emitting element formed with a bump, the substrate having an optical waveguide that is optically coupled to the light-emitting element, the bump being connected to electric wiring on the substrate,
wherein a transparent resin not containing a filler is applied to a portion corresponding to a light path for outgoing light from the light-emitting element to the substrate in such a manner that the transparent resin not containing a filler adheres to near a light-emitting point at which the light-emitting element emits light and to the substrate; and
a resin containing a filler is filled in a portion between the light-emitting element and the substrate, the portion being to be filled with the resin containing a filler.

2. The junction structure between a light-emitting element and a substrate according to claim 1, wherein the transparent resin not containing a filler is made of a transparent resin having a refractive index substantially equal to that of the substrate to which the transparent resin not containing a filler is made to adhere.

3. The junction structure between a light-emitting element and a substrate according to claim 1,
wherein the transparent resin not containing a filler is filled in an opening formed in a portion of the substrate that is made to adhere, the potion associated with the light path for outgoing light, for enabling passage of the outgoing light therethrough.

4. The junction structure between a light-emitting element and a substrate according to claim 2,
wherein the transparent resin not containing a filler is filled in an opening formed in a portion of the substrate that is made to adhere, the potion associated with the light path for outgoing light, for enabling passage of the outgoing light therethrough.

5. A junction structure between a light-receiving element and a substrate, the light-receiving element formed with a bump, the substrate having an optical waveguide that is optically coupled to the light-receiving element, the bump being connected to electric wiring on the substrate,
wherein a transparent resin not containing a filler is applied to a portion corresponding to a light path for incoming light from the substrate to the light-receiving element in such a manner that the transparent resin not containing a filler adheres to the substrate and to near a light-receiving point at which the light-receiving element receives light; and
a resin containing a filler is filled in a portion between the light-receiving element and the substrate, the portion being to be filled with the resin containing a filler.

6. The junction structure between a light-receiving element and a substrate according to claim 4, wherein the transparent resin not containing a filler is made of a transparent resin having a refractive index substantially equal to that of the substrate to which the transparent resin not containing a filler is made to adhere.

7. The junction structure between a light-receiving element and a substrate according to claim 4,
wherein the transparent resin not containing a filler is filled in an opening formed in a portion of the transparent resin on the substrate that is made to adhere, the potion associated with the light path for incoming light, for enabling passage of the incoming light therethrough.

8. The junction structure between a light-receiving element and a substrate according to claim 5,
wherein the transparent resin not containing a filler is filled in an opening formed in a portion of the transparent resin on the substrate that is made to adhere, the potion associated with the light path for incoming light, for enabling passage of the incoming light therethrough.

9. A light-transmitting/receiving module comprising the junction structure between a light-emitting element and a substrate according to claim 1 and the junction structure between a light-receiving element and a substrate according to claim 5.

10. The light-transmitting/receiving module according to claim 9,
wherein a driver for driving the light-emitting element and an output signal amplifier for the light-receiving element are mounted on the substrate.

11. The light-transmitting/receiving module according to claim 9,
wherein the substrate has flexibility.

12. The light-transmitting/receiving module according to claim 10,
wherein the substrate has flexibility.

13. A method of manufacturing an optical module, the method comprising:
a first step of supplying a transparent resin not containing a filler to a portion of a substrate having an optical waveguide that is optically coupled to an optical element, the portion functioning as a light path for light emitted from the optical element and/or for light incoming into the optical element;
a second step of mounting a bump provided for the optical element to electric wiring on the substrate with the transparent resin not containing a filler supplied thereon in the first step and joining the bump to the electric wiring;
a third step of allowing the transparent resin not containing a filler to adhere to the optical element and the substrate by thermally hardening the transparent resin not containing a filler in the state where the bump of the optical element is joined to the electric wiring on the substrate in the second step;
a fourth step of filling an under-fill resin containing a filler in a space between the light-receiving element and the substrate, to both of which the transparent resin not containing a filler has adhered in the third step; and
a fifth step of thermally hardening the under-fill resin containing a filler filled in the fourth step.

14. The method of manufacturing an optical module according to claim 13,
Wherein, in the third step, the transparent resin not containing a filler is thermally hardened such that the transparent resin not containing a filler adheres to only a portion near the light-emitting point or the light-receiving point of the optical element.

15. The method of manufacturing an optical module according to claim 13,
wherein, in the first step, before the transparent resin not containing a filler is supplied to the portion of the substrate functioning as the light path, an opening is formed in the portion through which light is to pass.

16. The method of manufacturing an optical module according to claim 14,
wherein, in the first step, before the transparent resin not containing a filler is supplied to the portion of the substrate functioning as the light path, an opening is formed in the portion through which light is to pass.
